(19) United States
(12) Patent Application Publication
(10) Pub. No.: US 2021/0179306 A1
(43) Pub. Date: Jun. 17, 2021

(54) VACUUM PRESERVATION MACHINE CAPABLE OF PRINTING DATE CODE

(71) Applicant: XIAMEN YOUO INTELLIGENT TECHNOLOGY CO., LTD., XIAMEN (CN)

(72) Inventor: YIYUN ZHOU, XIAMEN (CN)

(21) Appl. No.: 16/769,650

(22) PCT Filed: Nov. 30, 2018
(86) PCT No.: PCT/CN2018/118690

§ 371 Date: Jun. 4, 2020

(30) Foreign Application Priority Data
Dec. 4, 2017 (CN) 201721662485.6
Dec. 4, 2017 (CN) 201721664332.5

(51) Int. Cl. B65B 61/26; B41K 3/08; B65B 31/04

(52) U.S. Cl. CPC B65B 61/26; B65B 31/048; B41K 3/08

(57) ABSTRACT

A vacuum preservation machine capable of printing date codes, comprising an upper cover (20) and a lower cover (21) connected together and capable of opening and closing, the upper cover and the lower cover are respectively provided with an upper sealing cotton (22) and a lower sealing cotton (23) at corresponding positions, an upper side of the lower cover is provided with a preservation bag and the opening of the preservation bag is located on the inner side of the lower sealing cotton, when the upper cover is closed, the upper sealing cotton and lower sealing cotton can be fit together to formed a sealing chamber to vacuum the preservation bag, the upper cover is provided with a printing wheel at the position of the inner side of the upper sealing cotton; the lower cover is provided with a block (25) at the position of the inner side of the lower sealing cotton, and the opening of the preservation bag crosses the block so that the bag body of the preservation bag is placed on the upper side of the block; when the upper cover is closed, the printing wheel can press the bag body onto the block, effectively solving the problem of printing date codes.

### TECHNICAL FIELD

The present disclosure relates to a vacuum preservation machine capable of printing date codes.

### BACKGROUND

Current vacuum preservation machines generally do not have the function of printing production dates and batch number, so customers can not exactly know the production date of food in the preservation bag, so a vacuum preservation machine having a printing production date and batch number function is urgently needed.

### SUMMARY OF DISCLOSURE

The present disclosure provides a vacuum preservation machine capable of simultaneously printing date codes, which can effectively solve the above problems.

The disclosure is realized in this way:

A vacuum preservation machine capable of simultaneously printing date codes, comprising an upper cover and a lower cover connected together and capable of opening and closing, the upper cover and the lower cover are respectively provided with an upper sealing cotton and a lower sealing cotton at corresponding positions, an upper side of the lower cover is provided with a preservation bag and the opening of the preservation bag is located on the inner side of the lower sealing cotton, when the upper cover is closed, the upper sealing cotton and lower sealing cotton can be fit together to formed a sealing chamber to vacuum the preservation bag,

the upper cover is provided with a printing wheel at the position of the inner side of the upper sealing cotton;

the lower cover is provided with a block at the position of the inner side of the lower sealing cotton, and the opening of the preservation bag crosses the block so that the bag body of the preservation bag is placed on the upper side of the block;

when the upper cover is closed, the printing wheel can press the bag body onto the block.

Further, the block is hot-melt or stamped.

Further, the inner side of the sealing cotton is provided with a reservoir, the opening of the preservation bag extends into the reservoir.

Further, the block is located in the reservoir.

The beneficial effects of the present disclosure are:

The vacuum preservation machine of the disclosure provides a printing wheel and a block so that when the upper cover and the lower cover are locked or vacuum tightened, the upper printing wheel presses the preservation bag on the block of the lower cover, thus enabling the printing wheel to print date codes on the preservation bag, such as the date of today (month/day), so that the food vacuum storage time can be well tracked. Finally, the digital date of the surface of the preservation bag can be made clearer by setting a hot-melt or stamped block.

### BRIEF DESCRIPTION OF DRAWINGS

In order to provide a clearer description of the technical scheme of the present disclosure, it will be understood that the accompanying drawings required in the embodiments will be briefly described below, and that the following drawings only show some embodiments of the present disclosure, and therefore should not be regarded as a limitation of scope, and that, for ordinary technicians in the field, the drawings may be used in accordance with the requirements of the present disclosure without any creative effort. These drawings are available in other related drawings.

FIG. 1 is a schematic diagram of structure of a printing wheel of the disclosure.

FIG. 2 is the first illustration of the split structure of FIG. 1.

FIG. 3 is the second illustration of the split structure of FIG. 1.

FIG. 4 is a structural diagram of the retaining plate of FIG. 1.

FIG. 5 is a structural diagram of a vacuum preservation machine of the disclosure.

FIG. 6 is a structural diagram of a preservation bag as shown in FIG. 5.

FIG. 7 is a structural schematic diagram of an upper cover and a lower cover in the vacuum preservation machine of the disclosure when they fit together.

FIG. 8 is a cross-sectional view of FIG. 7.

### DETAILED DESCRIPTION

In order to make the purposes, technical schemes and advantages of the embodiments of the present disclosure clearer, the technical schemes of the embodiments of the present disclosure will be described clearly and completely below in conjunction with the accompanying drawings of the embodiments of the present disclosure. Obviously, the described embodiments are part of, but not all of, the embodiments of the present disclosure. Based on the embodiments of the disclosure, all other embodiments obtained by ordinary technicians in the art without creative work fall within the scope of protection of the disclosure. Accordingly, the following detailed description of the embodiments of the disclosure provided in the accompanying drawings is not intended to limit the scope of the disclosure requiring protection, but merely to represent selected embodiments of the disclosure. Based on the embodiments of the disclosure, all other embodiments obtained by ordinary technicians in the art without creative work fall within the scope of protection of the disclosure.

The disclosure is illustrated by way of example and not by way of limitation in the figures of the accompanying drawings in which like references indicate similar elements. It should be noted that references to “an” or “a” embodiment in this disclosure are not necessarily to the same embodiment, and such references mean “at least one.”

In the description of the present disclosure, the terms “first”, “second” are used only for descriptive purposes and cannot be understood as indicating or implying relative importance or implying the number of indicated technical features. Thus, a characteristic that is limited to “first” and “second” may include, expressly or implicitly, one or more of the characteristics. In the description of the present disclosure, “many” means two or more unless otherwise expressly and specifically limited.

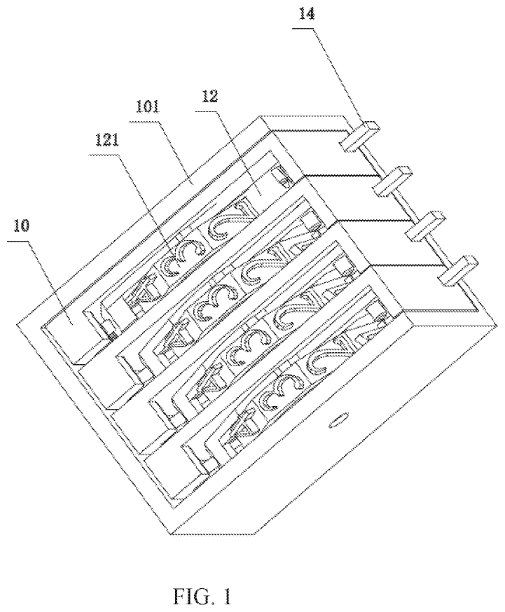

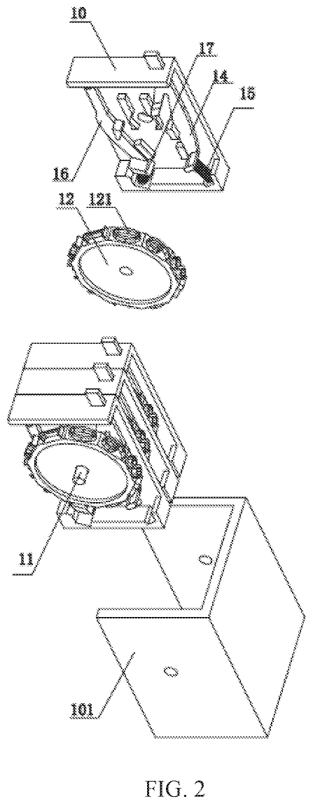

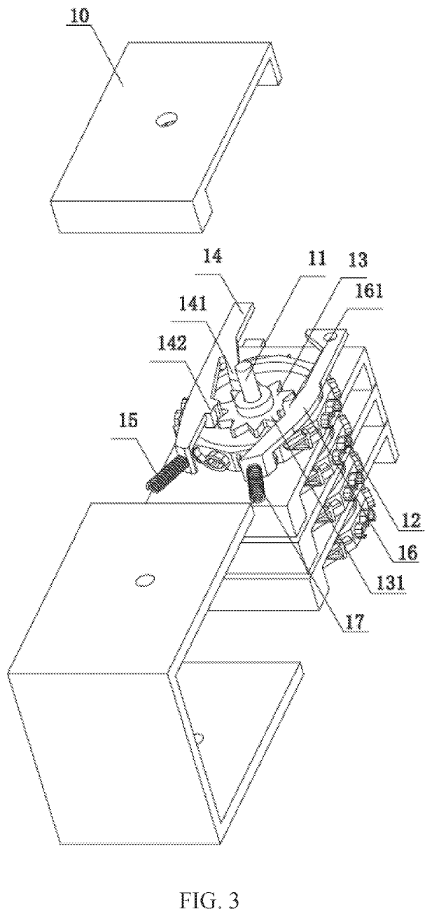

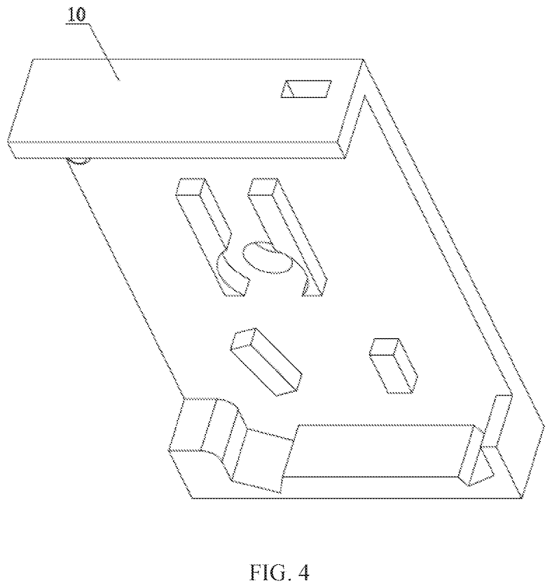

Referring to FIGS. 1-4, a printing wheel 100 for vacuum preservation machines includes:

a retaining plate 10:

a connecting shaft 11 fixedly arranged in the middle of the retaining plate 10;

a digital disc 12 surrounded by the required plural character templates 121 and is rotatably sleeved on the outside of the connecting shaft 11;

a gear 13 rotatably sleeved on the outside of the connecting shaft 11, is positioned between the retaining plate 10 and the digital disc 12 and is linked to the digital disc 12;

a first pushing rod 14 elastically connected to the retaining plate 10 and can abut against the gear 13. Pressing the first pushing rod 14 enables the first pushing rod 14 to push the gear 13 to rotate, thereby driving the digital disc 12 to rotate and releasing the first pushing rod 14, thereby restoring the first pushing rod 14 to its original state.

By the first pushing rod 14, the user can turn the digital disc 12 just by pushing the first pushing rod 14, thus changing the imprinted words, which is easy to operate and very suitable for the existing vacuum preservation machine. It can be used only by installing the printing wheel 100 in the vacuum preservation machine as a whole, without further modification of the vacuum preservation machine, thus saving production cost of the company.

Specifically, one end of the first pushing rod 14 extends through the retaining plate 10 to the outside of the retaining plate 10 to be pressed by the user, and the other end abut against the inner wall of the retaining plate 10 through a first spring 15.

Specifically, the side of the first pushing rod 14 is provided with a pushing block 141 and a first clamp block 142 for driving the gear 13 to rotate; when the first pushing rod 14 is not pushed, the first clamp block 142 is located between two adjacent teeth 131 on the gear 13. When in use, the user presses the first pushing rod 14 to extend to one end of the outer side of the retaining plate 10 to compress the first spring 15 at the other end, while the pushing block 141 pushes the gear to rotate. When pressed in place, the printed surface 121 of the digital disc 12 just changes from one character temple to another adjacent character temple. After releasing the pressure, the first pushing rod 14 is returned under the action of the first spring 15. At this time, the first clamp block 142 is set between the two teeth 131 to prevent the gear 13 from turning itself and to improve stability during printing.

The printing wheel 100 also includes a second pushing rod 16, one end of the second pushing rod 16 is rotatably connected to the retaining plate 10 and the other end abut against the inner wall of the retaining plate 10 through a second spring 17 with a second clamp block 161 on the side of the second pushing rod 16. When the first pushing rod 14 is not pushed, the second clamp block 161 is also clamped between two adjacent teeth on the gear 13. In addition, the first pushing rod 14 and the second pushing rod 16 are located on opposite sides of the gear 13, respectively, improving stability of digital disc 12 during printing.

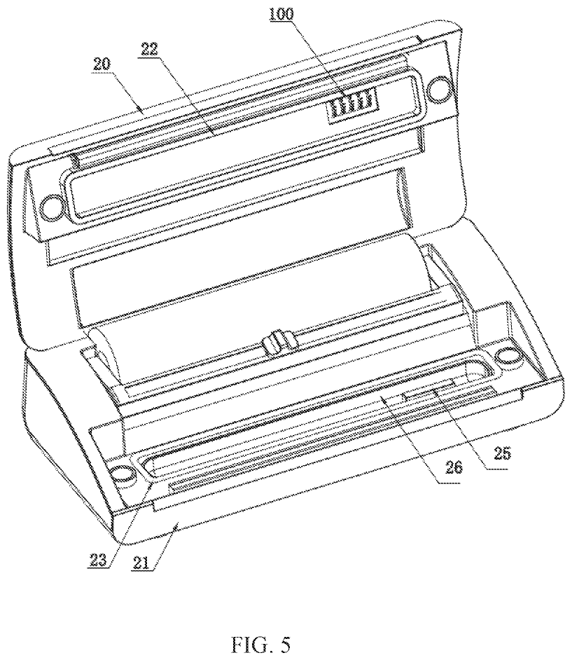

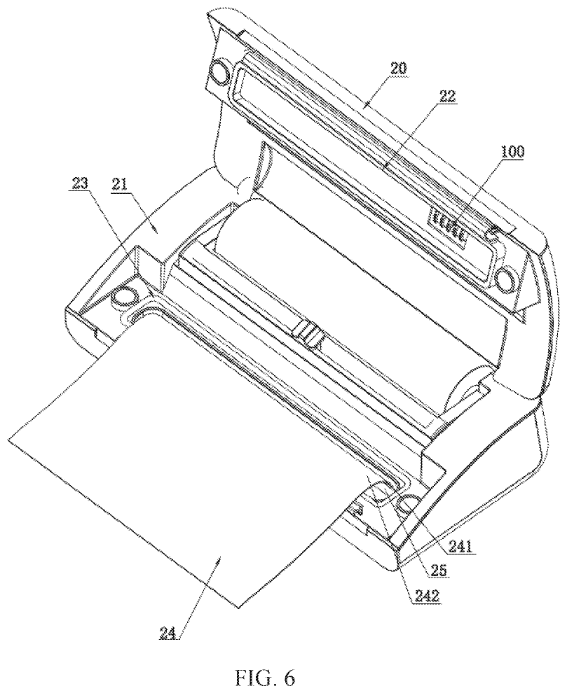

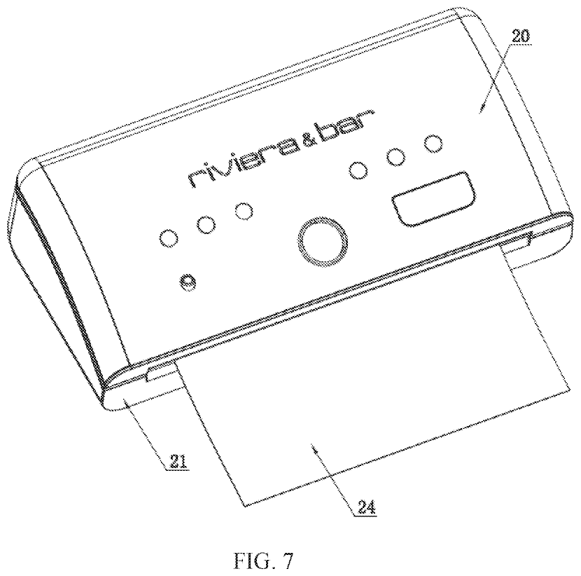

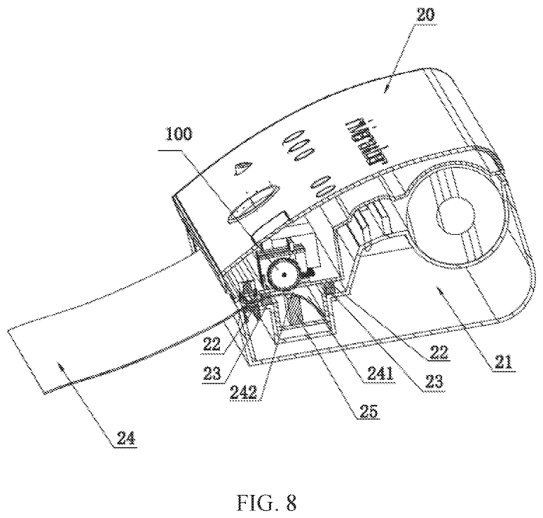

Referring to FIGS. 5-8, a vacuum preservation machine capable of simultaneously printing date codes, an upper cover 20 and a lower cover 21 connected together and capable of opening and closing, the upper cover 20 and the lower cover 21 are respectively provided with an upper sealing cotton 22 and a lower sealing cotton 23 at corresponding positions, an upper side of the lower cover 21 is provided with a preservation bag 24 and the opening 241 of the preservation bag 24 is located on the inner side of the lower sealing cotton 23, when the upper cover 20 is closed, the upper sealing cotton 22 and lower sealing cotton 23 can be fit together to formed a sealing chamber to vacuum the preservation bag 24.

One or a plurality of connected printing wheels 100 side-by-side can be mounted on the upper cover 20 and the printing surface of the printing wheel 121 faces down. When the upper cover 20 is closed to fit the lower cover 21, the printing wheel 100 can print the characters on the preservation bag 24 below. When there are a plurality of the printing wheel 100, it can be fixed together through the outer frame 10 to facilitate installation.

The printing wheel 100 is mounted on the upper cover 20 at the position of the inner side of the upper sealing cotton 22.

A block 25 is arranged on the upper part of the lower cover 21 at the position of the inner side of the lower sealing cotton 23, and the opening 241 of the preservation bag crosses the block 25 so that the bag body 242 of the preservation bag 24 is placed on the upper side of the block 25.

When the upper cover 20 is closed, the printing wheel 100 presses the bag body 242 on the block 25.

By setting the printing wheel 100 and block 25, the printing wheel 100 of the upper cover 20 will press the preservation bag 24 onto the block 25 of the lower cover 21 when the upper cover 20 and the lower cover 21 are locked or vacuum-tightened, so that the date code on the printing wheel 100 can be printed on the preservation bag 24, such as the date of today (month/day), thus the food vacuum storage time can be well tracked.

Specifically, the above mentioned block 25 is a hot melt or stamped. The digital date of the surface of the preservation bag 24 can be made clearer by setting a hot-melt or stamped block.

The inner side of the lower sealing cotton 23 has a reservoir 26, and the opening 241 of the preservation extends into the reservoir 26. This setting enables the juice overflow from the preservation bag 24 to flow directly into the reservoir when vacuum is pumped. After vacuum is pumped, it can be recycled again, thus avoiding contamination and damage to the machine. The block is located in the reservoir.

The above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A vacuum preservation machine capable of printing date codes, comprising:
an upper cover and a lower cover connected together and capable of opening and closing;
the upper cover and the lower cover respectively provided with an upper sealing cotton and a lower sealing cotton at corresponding positions, the upper side of the lower cover is provided with a preservation bag and the opening of the preservation bag is located on the inner side of the lower sealing cotton;
when the upper cover is closed, the upper sealing cotton and the lower sealing cotton can be fit together to formed a sealing chamber to vacuum the preservation bag, wherein the upper cover is provided with a printing wheel at the position of the inner side of the upper sealing cotton;
the lower cover is provided with a block at the position of the inner side of the lower sealing cotton, and the opening of the preservation bag crosses the block so that the bag body of the preservation bag is placed on an upper side of the block;
when the upper cover is closed, the printing wheel can press the bag body onto the block.

2. The vacuum preservation machine capable of printing date codes according to claim 1, wherein the block is hot-melt or stamped.

3. The vacuum preservation machine capable of printing date codes according to claim 1, wherein the inner side of the sealing cotton is provided with a reservoir, the opening of the preservation bag extends into the reservoir.

4. The vacuum preservation machine capable of printing date codes according to claim 3, wherein the block is located in the reservoir.
